(19) United States
(12) Patent Application Publication
(10) Pub. No.: US 2006/0152742 A1
(43) Pub. Date: Jul. 13, 2006

(54) Screen saver control apparatus, screen saver control method and screen saver control program

(75) Inventor: Yasutoshi Kawabata, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/325,455

(22) Filed: Jan. 5, 2006

(30) Foreign Application Priority Data
Jan. 12, 2005 (JP) 2005-005401
Mar. 3, 2005 (JP) 2005-059509

(51) Int. Cl. G06F 9/00

(52) U.S. Cl. 358/1.1; 715/867; 715/764; 715/778

(57) ABSTRACT

A screen saver control apparatus of an aspect of the present invention comprises a display section that displays a screen saver for sequentially switching introduction screens about a plurality of operation modes, an operation section that accepts an operation input, and a control section that performs an operation mode corresponding to an introduction screen displayed when the operation input is accepted. According to the screen saver control apparatus, when an operation is inputted on any of the introduction screens the display of which are sequentially switched by the screen saver, transition to a mode corresponding to the introduction screen is performed. Therefore, it is possible to immediately transition to a desired service without performing complicated operations while understanding the function of each mode.

### BACKGROUND OF THE INVENTION

1. Field of the Invention

The present invention relates to a screen saver control apparatus, a screen saver control method and a screen saver control program, in particular to a screen saver capable of transitioning to a mode for performing a particular function.

2. Description of the Related Art

There have been developed techniques for adding various functions to a screen saver to be displayed to prevent burning-in to a screen. For example, according to Japanese Patent Application Laid-Open No. 2002-282426, by installing a mini game on a pachinko machine in addition to a regular game and recording the progress of the mini game, replay images are used as a screen saver. Thereby, it is possible to prevent burning-in to a screen more effectively than repeatedly displaying a single screen saver.

According to an image capture apparatus of Japanese Patent Application Laid-Open No. 2001-238123, a trigger device generates a start trigger signal indicating an instruction to start image taking in response to a button operation by a user and supplies it to a control device. A detection device detects whether or not a recording medium exists and supplies a detection signal indicating the result to the control device. The control device supplies a first control signal to a feature device and a second control signal to a recorder device, in accordance with the supplied start trigger signal and detection signal. An image capture device captures an image of an object and supplies a picture signal to the feature device. The feature device performs effect processing for the picture signal in accordance with the supplied first control signal and supplies it to the recorder device. The recorder device performs high efficiency coding of the picture signal supplied from the feature device and records it to the recording medium. This progress is displayed as demonstration on a display device so that the functions are introduced to a user.

### SUMMARY OF THE INVENTION

Equipment mounted with a lot of functions, such as a point-of-sales print acceptance apparatus, may require a user to operate complicated operations to perform the functions, and therefore, it is necessary to transition to an operation screen for performing the functions as easily as possible. However, in the technique of Japanese Patent Application Laid-Open No. 2002-282426, only switching between a demonstration screen and a mini game screen is performed. In the technique of Japanese Patent Application Laid-Open No. 2001-238123 also, only transition to a demonstration screen is performed by an operation to start image taking. The demonstration screen is not provided with a function of specifying transition to a particular screen. The present invention has been made in consideration of such a problem, and its object is to enable various functions to be easily performed from a screen saver.

In order to solve the above problem, a screen saver control apparatus according to a first aspect of the present invention comprises: a display section which displays a screen saver for sequentially switching introduction screens about a plurality of operation modes; an operation section which accepts an operation input; and a control section which performs an operation mode corresponding to an introduction screen displayed when the operation input is accepted.

According to the first aspect of the present invention, when an operation is inputted on any of the introduction screens the display of which are sequentially switched by the screen saver, transition to a mode corresponding to the introduction screen is performed. Therefore, it is possible to immediately transition to a desired service without performing complicated operations while understanding the function of each mode.

The screen saver control apparatus may further comprise a setting section that sets which of the screen saver for sequentially switching introduction screens about the plurality of operation modes and an ordinary screen saver should be set to operate; and the control section may be adapted to cause any one of the screen saver for sequentially switching introduction screens about the plurality of operation modes and the ordinary screen saver to operate, based on the setting by the setting section.

Thereby, when an operation is inputted to an operation section during the ordinary screen saver operation, that is, during the ordinary screen saver screen being displayed, as needed, the screen saver screen can be returned to a predetermined screen.

A screen saver control method according to a second aspect of the present invention includes the steps of: displaying a screen saver for sequentially switching introduction screens about a plurality of operation modes; accepting an operation input; and performing an operation mode corresponding to an introduction screen displayed when the operation input is accepted.

A screen saver control program according to a third aspect of the present invention causes a computer to perform the steps of: displaying a screen saver for sequentially switching introduction screens about a plurality of operation modes; accepting an operation input; and performing an operation mode corresponding to an introduction screen displayed when the operation input is accepted.

According to the second and the third aspect of the present invention, when an operation is inputted on any of the introduction screens the display of which are sequentially switched by the screen saver, transition to a mode corresponding to the introduction image is performed. Therefore, it is possible to immediately transition to a desired service without performing complicated operations while understanding the function of each mode.

### BRIEF DESCRIPTION OF THE DRAWINGS

FIG. 1 is a block diagram of a point-of-sales print terminal according to a preferred embodiment of the present invention;

FIG. 2 is a flowchart showing the flow of a process to be performed by a point-of-sales print terminal according to a first embodiment;

FIG. 3 is shows an example of a first menu screen;

FIG. 4 is shows an example of a second menu screen;

FIG. 5 is shows an example of a screen saver;

FIG. 6 is shows an example of a maintenance screen; and

FIG. 7 is a flowchart showing the flow of a process to be performed by a point-of-sales print terminal according to a second embodiment.

### DETAILED DESCRIPTION OF THE PREFERRED EMBODIMENTS

Preferred embodiments of the present invention will be described below with reference to accompanying drawings.

### First Embodiment

Outline Configuration

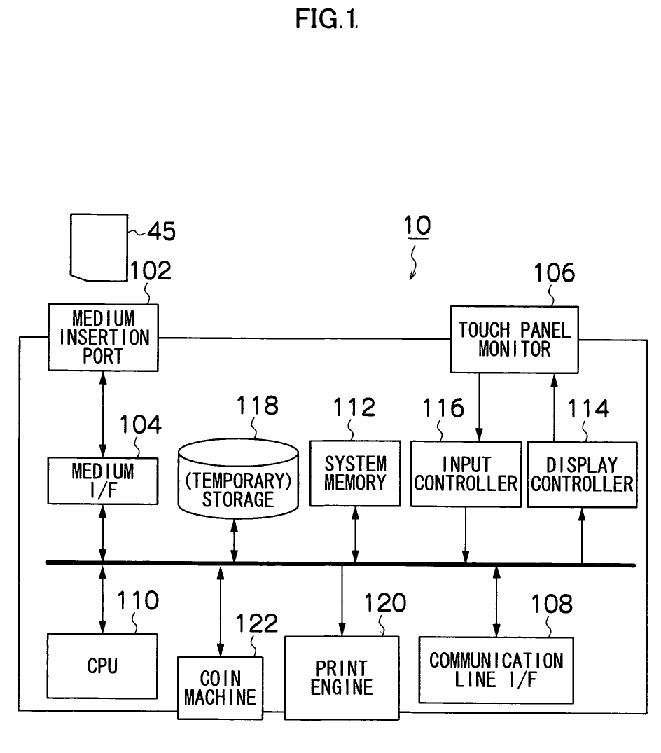

FIG. 1 is a block diagram showing an embodiment of a point-of-sales print terminal 10 according to a preferred embodiment of the present invention. As shown in the figure, the point-of-sales print terminal 10 is provided with a medium insertion port 102 through which a recording medium 45, such as a Smart Media (registered trade mark) card, a Memory Stick (registered trade mark) card, a Compact Flash (registered trade mark) card and a CD-R, is inserted, a medium interface 104, a touch-panel-equipped monitor 106, and a communication line interface 108 capable of sending and receiving necessary information via a communication line network.

On the touch-panel-equipped monitor 106, images recorded on the recording medium 45 inserted into the medium insertion port 102, operation buttons to be operated on the touch panel, and the like are displayed.

The point-of-sales print terminal 10 is also provided with a central processing unit (CPU) 110 which controls the entire point-of-sales print terminal 10, a system memory 112 configured by a ROM in which programs to cause the CPU 110 to operate are written and a RAM to be a work area when the CPU 110 performs processing, a display controller 114 which outputs information to be displayed on the touch-panel-equipped monitor 106, and an input controller 116 for inputting print setting information such as selection of an image to be printed, the number of prints (“1” is set as default) and the kind, with the use of the touch-panel-equipped monitor 106.

The point-of-sales print terminal 10 is also provided with a storage 118 which temporarily stores information about images acquired from the recording medium 45 inserted in the medium insertion port 102 or via the communication line I/F 108, the print setting information and the like, a print engine 120 which prints an image stored in the storage 118 based on the print setting information, and a coin machine 122.

Process Flow

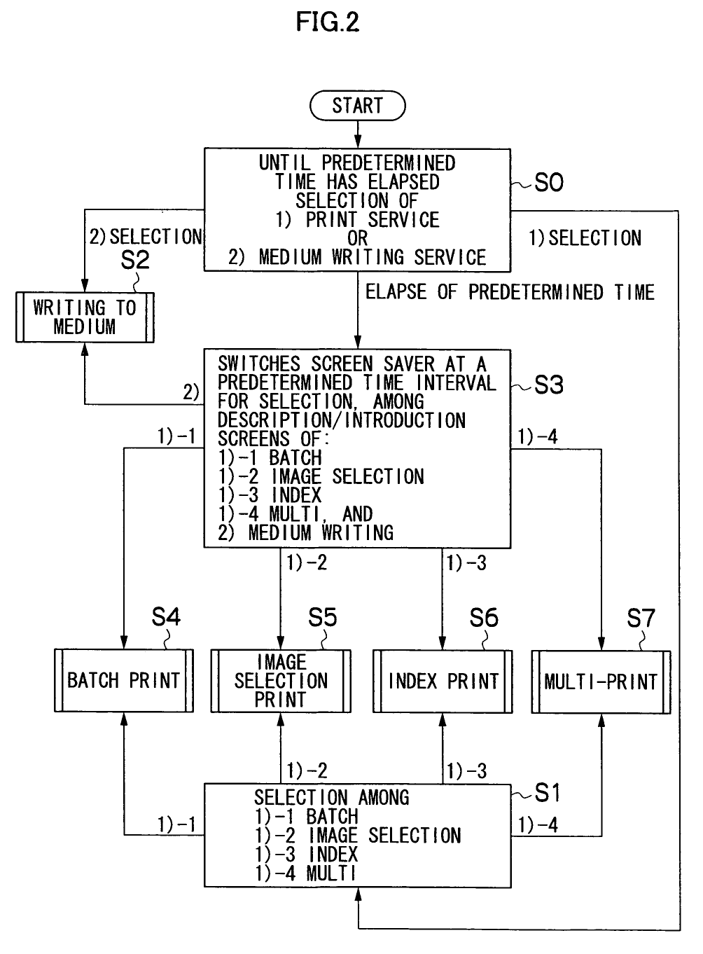

The flow of a process to be performed by the point-of-sales print terminal 10 will be described below in accordance with the flowchart in FIG. 2.

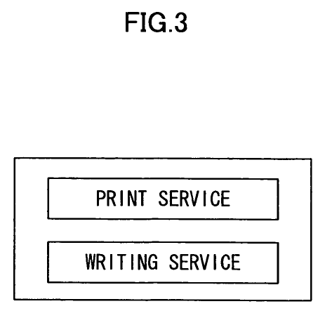

At S0, a first menu screen provided with an operation button for selecting a print service mode or a medium writing service mode is displayed on the touch-panel-equipped monitor 106 until a predetermined time (for example, five to ten minutes) has elapsed. FIG. 3 is a display example of the first menu screen. On this screen, selection of the print service or the medium writing service is accepted by the operation button displayed on the touch-panel-equipped monitor 106 being depressed. If the print service is selected on this screen, then the process proceeds to S1. If the medium writing service is selected, then the process proceeds to S2. If the predetermined time has elapsed without anything being selected, then the process proceeds to S3.

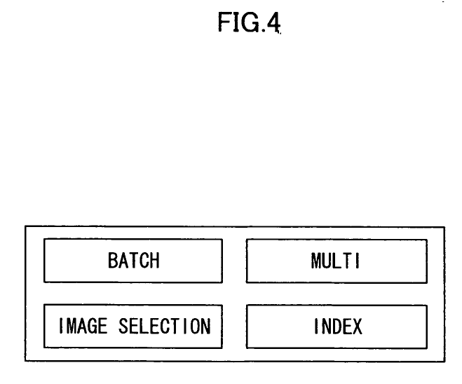

At S1, a second menu screen is displayed on the touch-panel-equipped monitor 106, which is provided with an operation button for performing selection among a batch print mode, an image selection print mode, an index print mode and a multi-print mode constituting the print service mode. FIG. 4 is a display example of the second menu screen. On this screen, selection of the batch print mode, the image selection print mode, the index print mode or the multi-print mode is accepted by the operation button displayed on the touch-panel-equipped monitor 106 being depressed. If the batch print mode is selected on this screen, then the process proceeds to S4, and if the image selection print mode is selected, then the process proceeds to S5. If the index print mode is selected, then the process proceeds to S6, and if the multi-print mode is selected, then the process proceeds to S7.

At S2, the medium writing service mode is performed in which images read from a Memory Stick card or a Compact Flash card is outputted and recorded to a CD-R medium inserted in the medium insertion port 102.

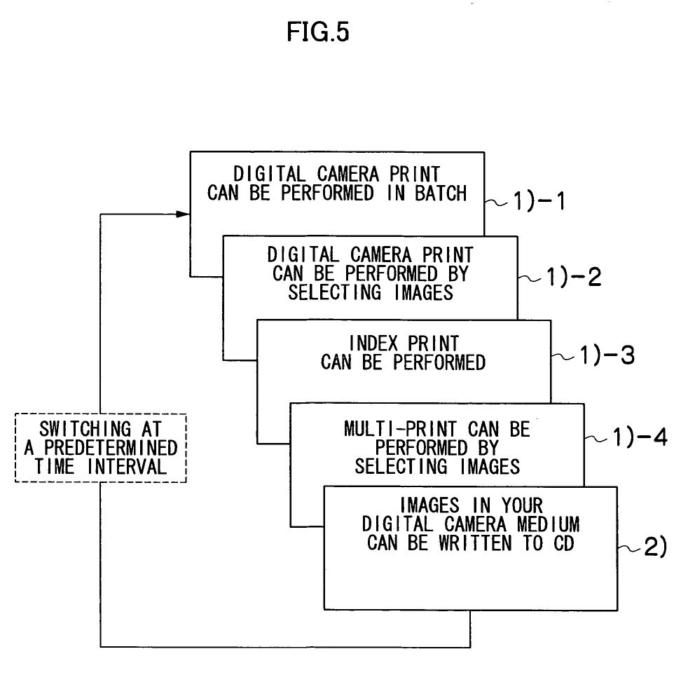

At S3, a screen saver is displayed on the touch-panel-equipped monitor 106 which sequentially switches introduction screens for individually introducing the batch print mode, the image selection print mode, the index print mode and the multi-print mode constituting the print service mode, and the medium writing service mode. As shown in FIG. 5, this screen saver sequentially switches the introduction screens of a batch print introduction screen 1)-1, an image selection print introduction screen 1)-2, an index print introduction screen 1)-3, a multi-print introduction screen 1)-4 and a medium writing introduction screen 2) at a predetermined time interval. When the predetermined time elapses after the introduction screen 2) is displayed, the screen returns to the introduction screen 1)-1 again. By repeating switching among the introduction screens at a predetermined time interval, burning-in of the touch-panel-equipped monitor 106 is prevented.

If an operation is inputted on the touch-panel-equipped monitor 106 when the batch print introduction screen 1)-1 is displayed, then the process proceeds to the batch print mode (S4). In the batch print mode of S4, for each of all images read from the recording medium 45 inserted in the medium insertion port 102, prints of the kind and number specified from the touch-panel-equipped monitor 106 are outputted.

If an operation is inputted on the touch-panel-equipped monitor 106 when the image selection print introduction screen 1)-2 is displayed, then the process proceeds to the image selection print mode (S5). In the image selection print mode of S5, images to be printed and the number and kind of prints of each image are caused to be selected and specified, and the specified kind and number of prints of the selected images are printed.

If an operation is inputted on the touch-panel-equipped monitor 106 when the index print introduction screen 1)-3 is displayed, then the process proceeds to the index print mode (S6). In the index print mode of S6, all images included in all image files read from the recording medium 45 inserted in the medium insertion port 102 are reduced, and prints with the same size as a single print are outputted in a predetermined order.

If an operation is inputted on the touch-panel-equipped monitor 106 when the multi-print introduction screen 1)-4 is displayed, then the process proceeds to the multi-print mode (S7). In the multi-print mode of S7, a predetermined number of images (for example, four images) among images read from the recording medium 45 are reduced, and prints with the same size as a single print are outputted.

If an operation is inputted on the touch-panel-equipped monitor 106 when the medium writing introduction screen 2) is displayed, then the process proceeds to the medium writing introduction mode (S2).

It is also possible that, if a depressing operation at a predetermined position is inputted on each introduction screen to be sequentially switched by the screen saver (for example, a lower right portion of the screen), transition to a mode corresponding to the introduction screen is performed, and if a depressing operation at any position other than the predetermined position is inputted, the screen returns to the first menu screen.

As described above, the point-of-sales print terminal 10, which has a lot of service functions such as the batch print mode, the image selection print mode, the index print mode, the multi-print mode and the medium writing mode, displays a screen introducing each mode by means of the screen saver. And, if an operation is inputted on the touch panel monitor 106 when the introduction screen is displayed, then the point-of-sales print terminal 10 transitions to the mode introduced by the introduction screen. Accordingly, a user can immediately transition to a desired service without troublesome operations while sufficiently understanding the function of each mode.

In the embodiment described above, description has been made on an example in which the present invention is applied to a point-of-sales print terminal. However, the application scope of the present invention is not limited thereto, and the present invention can be similarly applied to a digital camera, a game machine, an ATM and the like. That is, a program for causing all or a part of the above-described processing steps may be stored in a computer readable storage medium such as a semiconductor memory so that various apparatuses having an operation processing device such as a CPU and an MCU can read and execute the program as appropriate.

### Second Embodiment

A screen saver having a function of transitioning to a touch-specified operation mode may be operated independently as in the first embodiment. In some cases, however, when an operation is inputted to an operation device such as the touch-panel-equipped monitor 106 during an ordinary screen saver being operated, that is, during a screen saver screen being displayed, it may be more convenient to cause the screen saver screen to return to a predetermined screen (such as the first menu screen and the second menu screen). Therefore, any of the ordinary screen saver and the screen saver with a function of transitioning to a specified operation mode (hereinafter referred to as a screen saver with an operation mode specification function) may be arbitrarily set to operate in advance so that the set screen saver operates.

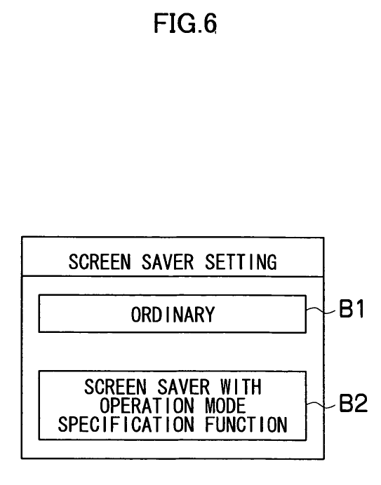

For example, a maintenance screen as shown in FIG. 6 is provided so that a maintenance administrator can set in advance any one of the ordinary screen saver and the screen saver with an operation mode specification function. The maintenance screen displayed on the touch-panel-equipped monitor 106 is provided with an “ordinary” button B1 and an “operation mode performing function added” button B2. If the “ordinary” button B1 is touch-selected on this screen, then the CPU 110 sets the ordinary screen saver. If the “operation mode performing function added” button B2 is touch-selected, then the CPU 110 sets the screen saver with an operation mode specification function. Once the setting is completed, the content thereof is held in the ROM of the system memory 112 and is not changed until new setting is made.

The maintenance screen is locked with a password or the like so that a general user cannot operate it.

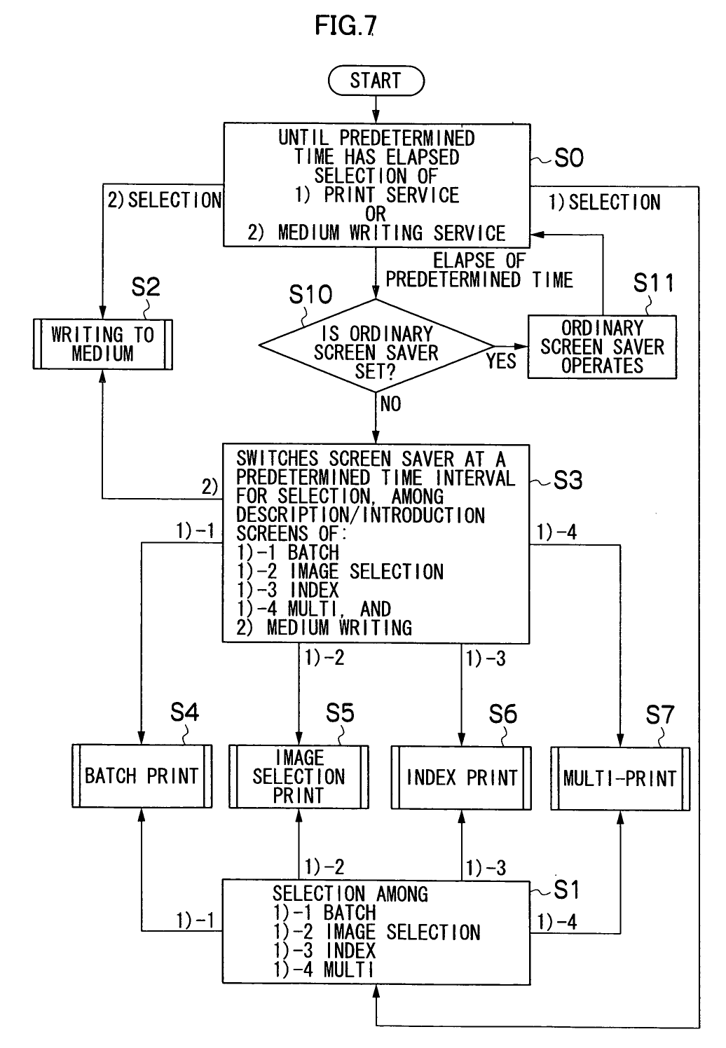

FIG. 7 is a flowchart showing the flow of a process to be performed by the point-of-sales print terminal 10 according to the second embodiment. Since steps S1 to S7 of this flowchart are equivalent to those for the first embodiment, description thereof will be omitted.

The content of processing as S0 is partly different from that in the first embodiment. That is, the first menu screen is displayed on the touch-panel-equipped monitor 106 until a predetermined time has elapsed, and the process proceeds to S1 when the print service is selected and to S2 when the medium writing service is selected. However, the process proceeds to S10 if the predetermined time has elapsed without anything being selected.

At S10, it is determined which of the ordinary screen saver and the screen saver with an operation mode specification function is set. If the screen saver with an operation mode specification function is set, then the process proceeds to S3, and if the ordinary screen saver is set, then the process proceeds to S11.

At S11, until any operation is inputted to the touch-panel-equipped monitor 106, a predetermined screen saver screen (not especially limited to any screen only if the displayed content is not fixed but dynamic) for preventing burning-in of the touch-panel-equipped monitor 106 is displayed. If any operation is inputted, the screen returns to the first menu screen.

Thus, it is also possible to cause the ordinary screen saver to operate based on the setting on the maintenance screen.

What is claimed is:

1. A screen saver control apparatus, comprising:
a display section which displays a screen saver for sequentially switching introduction screens about a plurality of operation modes;
an operation section which accepts an operation input; and
a control section which performs an operation mode corresponding to an introduction screen displayed when the operation input is accepted.

2. The screen saver control apparatus according to claim 1, further comprising:
a setting section that sets which of the screen saver for sequentially switching the introduction screens about the plurality of operation modes and an ordinary screen saver should be set to operate,
wherein the control section causes any one of the screen saver for sequentially switching the introduction screens about the plurality of operation modes and the ordinary screen saver to operate, based on the setting by the setting section.

3. A screen saver control method, comprising the steps of:
displaying a screen saver for sequentially switching introduction screens about a plurality of operation modes;
accepting an operation input; and
performing an operation mode corresponding to an introduction screen displayed when the operation input is accepted.

4. A screen saver control program which causes a computer to perform the steps of:
displaying a screen saver for sequentially switching introduction screens about a plurality of operation modes;
accepting an operation input; and
performing an operation mode corresponding to an introduction screen displayed when the operation input is accepted.
